(19) United States
(12) Patent Application Publication
(10) Pub. No.: US 2008/0284321 A1
(43) Pub. Date: Nov. 20, 2008

(54) Organic light-emitting display device

(76) Inventors: Masahiro Tanaka, Chiba (JP); Toshiyuki Matsuura, Mobara (JP); Sukekazu Aratani, Hitachi (JP); Masao Shimizu, Hitachi (JP)

Correspondence Address: REED SMITH LLP, Suite 1400, 3110 Fairview Park View, Falls Church, VA, 22042, US

(21) Appl. No.: 11/987,084

(22) Filed: Nov. 27, 2007

(30) Foreign Application Priority Data
Nov. 29, 2006 (JP) 2006-321516

(51) Int. Cl. H01J 1/63

(52) U.S. Cl. 313/504

(57) ABSTRACT

Provided is a top emission type organic light-emitting display device having the emission luminance thereof improved by increasing a quantity of electrons injected into an electron injection layer. At least a cathode, an electron injection layer, an electron transport layer, a light-emitting layer, a hole transport layer, and an anode are sequentially accumulated on an insulating substrate. The electron injection layer is formed with a co-deposited layer having both tris(8-hydroxyquinoline)aluminum (Alq₃) and lithium (Li) evaporated thereon. The electron transport layer is formed with a deposited layer having tris (8-hydroxyquinoline)aluminum (Alq₃) evaporated thereon. The ratio of Li to Alq₃ in the co-deposited layer is equal to or larger than 1 and equal to or smaller than 3. The thickness of the co-deposited layer is equal to or larger than 1 nm and equal to or smaller than 3 nm. The thickness of the Alq₃-deposited layer is equal to or larger than 5 nm and equal to or smaller than 7.5 nm. Consequently, a quantity of resistive components decreases, a current increases, and a quantity of electrons injected into the light-emitting layer increases (the electron mobility gets larger). Eventually, the emission luminance improves.

### CROSS-REFERENCE TO RELATED APPLICATIONS

The disclosure of Japanese Patent Application No. 2006-321516 filed on Nov. 29, 2006 (yyyy/mm/dd) including the claims, the specification, the drawings, and the abstract is incorporated herein by reference in its entirety.

### BACKGROUND

1. Field of the Invention

The present invention relates to an organic light-emitting display device that has an organic light-emitting layer interposed between a pair of electrodes and that causes the organic light-emitting layer to emit light by inducing an electric field in the organic light-emitting layer using the pair of electrodes. More particularly, the invention is concerned with a laminated structure that includes an electron transport layer and an electron injection layer, that is formed using an organic material, and that is joined to the organic light-emitting layer.

2. Description of the Related Art

In recent years, organic light-emitting display devices have been attracting attention as next-generation flat display devices. The organic light-emitting display device has the excellent properties of being emissive, offering a wide viewing angle range, and being highly responsive. The organic light-emitting display device falls into a so-called bottom emission type and a so-called top emission type.

The bottom emission type organic light-emitting display device has organic light-emitting elements thereof realized with a luminous mechanism. The luminous mechanism has a transparent electrode that is made of indium tin oxide (ITO) or the like and that serves as a first electrode or one electrode, an organic light-emitting layer (may be referred to as an organic multilayer film) that emits light responsively to induction of an electric field, and a reflective metallic electrode, which serves as a second electrode or the other electrode, sequentially accumulated on an insulating substrate that is preferably a glass substrate. Numerous organic light-emitting elements are arranged in the form of a matrix, and another substrate that may be referred to as a sealing can and that covers the laminated structure is included in order to shield the light-emitting structure from an external atmosphere.

For example, the transparent electrode is adopted as an anode and the metallic electrode is adopted as a cathode. When an electric field is induced in the inter-electrode space, a carrier (electrons and holes) is injected into the organic light-emitting layer. This causes the organic light-emitting layer to emit light. The light is radiated to outside from the glass substrate side of the display device.

On the other hand, in the top emission type organic light-emitting display device, the aforesaid one electrode is a reflective metallic electrode, and the other electrode is a transparent electrode made of ITO or the like. When an electric field is induced in the inter-electrode space, the organic light-emitting layer emits light, and the light is radiated from the other electrode side of the display device. In the top emission type, a transparent substrate that is preferably a glass substrate is adopted as the sealing can employed in the bottom emission type.

In the thus constructed organic light-emitting display device, when the organic light-emitting elements emit light, a carrier is injected into the organic light-emitting layer included in the luminous mechanism according to an electric field induced in the interspace between one electrode and the other electrode. The thickness of each of the layers realizing the organic light-emitting elements ranges from about several tens of nanometers to about several hundreds of nanometers, and is susceptible to an optical-interference effect. The interferential effect is utilized in order to improve luminous efficiency in each of red, green, and blue.

In recent years, an organic light-emitting display device capable of realizing high-luminance light emission with a low voltage by employing silole in forming the electron transport layer and light-emitting layer has been disclosed in patent documents 1, 2, and 3 as one of improvements intended to improve the luminous efficiency for the purpose of paving the way for the practical use of the organic light-emitting display device.

Moreover, a patent document 4 has disclosed an organic light-emitting display device that has the luminous efficiency and heat resistance thereof improved by including an anthracene derivative in the light-emitting layer.

Further, a patent document 5 has disclosed an organic light-emitting display device capable of realizing excellent luminous efficiency and a long lifetime by including a distyrylarylene derivative in the light-emitting layer.

Moreover, a patent document 6 has disclosed an organic light-emitting display device capable of realizing an emission color of blue by including a hydrogenated amorphous silicon carbide (a-SiC:H) in the light-emitting layer.

By the way, the patent document 1 refers to JP-A-09-087616, the patent document 2 refers to JP-A-09-194487, the patent document 3 refers to JP-A-10-017860, the patent document 4 refers to WO01/072673 under PCT, the patent document 5 refers to JP-A-2000-273055, and the patent document 6 refers to JP-A-06-204562.

### SUMMARY

However, when it comes to an organic light-emitting display device that is constructed as mentioned above, if the organic light-emitting display device is of the top emission type, the fact that a laminated structure including one electrode (a metallic electrode having reflectivity and serving as a cathode) through which electrons are injected, an electron injection layer, and an electron transport layer seriously affects the emission intensity and current efficiency has been disclosed in the course of optimizing the lamination. Namely, various merits and demerits have been revealed in the course of optimizing the lamination. This poses a problem in that high-luminance emission and a long lifetime are hardly attained.

Accordingly, the invention addresses the aforesaid problem underlying the related art. An object of the invention is to provide a top emission type organic light-emitting display device that has the emission luminance improved by increasing a quantity of electrons injected to an electron injection layer.

In order to accomplish the object, an organic light-emitting display device in accordance with the invention has at least a cathode, an electron injection layer, an electron transport layer, alight-emitting layer, a hole transport layer, and an anode sequentially accumulated on an insulating substrate. Since the electron injection layer is formed with a layer deposited by a co-evaporation method (hereinafter referred to as “co-deposited layer”) having both tris(8-hydroxyquinoline)aluminum (Alq₃) and lithium (Li) evaporated thereon, and the electron transport layer is formed with a layer deposited by a evaporation method (hereinafter referred to as “deposited layer”) having tris(8-hydroxyquinoline) aluminum (Alq₃) evaporated thereon, a quantity of resistive components of the co-deposited layer decreases, a current increases, and a quantity of electrons injected into the light-emitting layer increases (the electron mobility gets larger). Consequently, emission luminance improves. Eventually, the problem underlying the background art can be solved.

Moreover, another organic light-emitting display device in accordance with the invention has the same construction as the foregoing one. Preferably, the ratio of tris(8-hydroxyquinoline)aluminum to lithium in the co-deposited layer serving as the electron injection layer is equal to or larger than 1 and equal to or smaller than 3.

Moreover, another organic light-emitting display device in accordance with the invention has the same construction as the foregoing one. Preferably, the thickness of the co-deposited layer of tris(8-hydroxyquinoline)aluminum and lithium serving as the electron injection layer is equal to or larger than 1 nm and equal to or smaller than 3 nm.

Moreover, another organic light-emitting display device in accordance with the invention has the same construction as the foregoing one. Preferably, the thickness of a deposited layer of tris(8-hydroxyquinoline)aluminum evaporated thereon and serving as the electron transport layer is equal to or larger than 5 nm and equal to smaller than 7.5 nm.

The invention is not limited to the foregoing constructions and a construction described in relation to an embodiment later. Needless to say, the invention can be modified in various manners without a departure from the technological idea of the invention.

According to the invention, since a quantity of electrons injected to a light-emitting layer increases, the excellent advantage of making it possible to realize a top emission type organic light-emitting display device which offers high emission luminance can be provided.

Moreover, according to the invention, since the performance of a top emission type organic light-emitting device becomes substantially level with that of a bottom emission type organic light-emitting device, the excellent advantage of making it possible to realize an organic light-emitting display device that features high luminance and a long lifetime owing to a high aperture ratio can be provided.

### BRIEF DESCRIPTION OF THE DRAWINGS

FIG. 1 is a sectional view of a major portion of an embodiment of an organic light-emitting display device in accordance with the invention showing the structure of organic light-emitting elements;

FIG. 2 shows the relationship of an emission luminance to the thickness of a co-deposited layer that is made of Li and Alq₃ and serves as an electron injection layer;

FIG. 3 shows the relationship of an emission luminance to the film thickness of Alq₃ made into an electron transport layer;

FIG. 4 shows the relationship of a current density to the film thickness of Alq₃ made into the electron transport layer;

FIG. 5 shows the relationship of a luminous current efficiency to the film thickness of Alq₃ made into the electron transport layer; and

FIG. 6 shows the relationship of a power efficiency to the film thickness of Alq₃ made into the electron transport layer.

### DETAILED DESCRIPTION OF THE INVENTION

Referring to the drawings, exemplary embodiments of the invention will be detailed below.

### First Embodiment

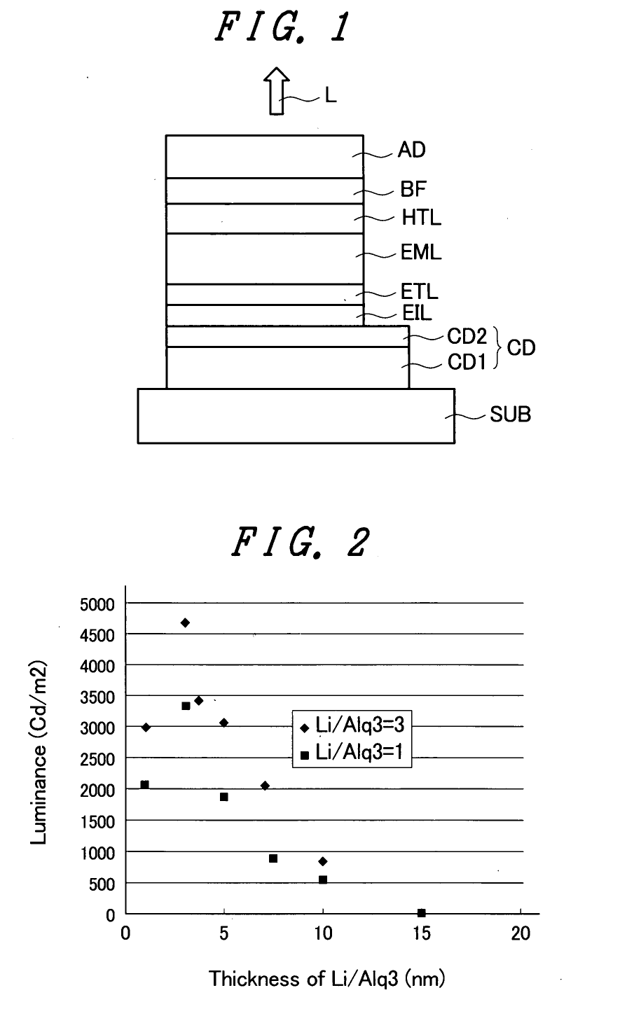

FIG. 1 is an illustrative enlarged sectional view of a major portion of an embodiment of an organic light-emitting display device in accordance with the invention, and is used to explain the structure of organic light-emitting elements according to a manufacturing process. To begin with, as shown in FIG. 1, an insulating alkali-free glass substrate SUB having a thickness of, for example, 1.1 mm is coated with aluminum (Al) by a thickness of approximately 200 nm according to a vacuum evaporation method in order to form a reflective electrode CD1. Thereafter, a film of approximately 35 nm thick is formed using, for example, indium tin oxide (ITO) according to the vacuum evaporation method in order to produce a transmissive electrode CD2. The reflective electrode CD1 and transmissive electrode CD2 constitute a cathode CD having optical reflectivity. Incidentally, indium zinc oxide (IZO) may be substituted for ITO.

Thereafter, the cathode CD is coated with lithium (Li) and tris(8-hydroxyquinoline)aluminum (Alq₃) by a thickness of approximately 3 nm according to a co-evaporation method, whereby an electron injection layer EIL is formed. Thereafter, the electron injection layer EIL is coated with tris(8-hydroxyquinoline)aluminum (Alq₃) by a thickness of approximately 7.5 nm according to the vacuum evaporation method, whereby an electron transport layer ETL is formed.

For the foregoing lamination, according to the present embodiment, the thickness of the electron injection layer EIL is approximately 3 nm. In practice, the thickness ranges from approximately 1 nm to 3 nm. Moreover, although the thickness is the electron transport layer ETL is described to be approximately 7.5 nm, the thickness ranges from approximately 5 nm to 7.5 nm in practice.

Thereafter, the electron transport layer ETL is coated with a green light emission material, for example, tris(8-hydroxyquinolino)aluminum (Alq) by a thickness of approximately 40 nm according to the vacuum evaporation method in order to form an organic light-emitting layer EML. Thereafter, the organic light-emitting layer EML is coated with, for example, 1-allyl-1,2,3,4,5-pentaphenylsilacyclopentadiene (APS) that is an organic material excellent in the stability of an anion or cation radical and that is a silacyclopentadiene derivative, in which the hole mobility and electron mobility are equal to each other, by a thickness of approximately 20 nm according to the vacuum evaporation method. This results in a hole transport layer HTL.

Thereafter, the hole transport layer HTL is coated with vanadium pentoxide (V₂O₅) by a thickness of approximately 10 nm according to, for example, the vacuum evaporation method in order to form a buffer layer BF. The buffer layer BF is coated with, for example, IZO by a thickness of approximately 60 nm according to a sputtering method in order to form an anode AD. Incidentally, ITO may be substituted for IZO.

When a V₂O₅ film is used as the buffer layer BF, since the V₂O₅ film has the capability of a hole transport layer, holes can be injected directly into the light-emitting layer EML without formation of the hole injection layer and hole transport layer HTL. Moreover, the V₂O₅ film has the capability of a protection layer against the sputtering performed to form the organic light-emitting layer EML and the ability to prevent oxidation.

In the thus produced organic light-emitting display device, a direct voltage is applied to each of the anode AD and cathode CD included in each organic light-emitting element so that the anode will be positively charged and the cathode will be negatively charged. Consequently, transfer of holes from the hole transport layer HTL to the light-emitting layer EML and transfer of electrons from the electron transport layer ETL to the light-emitting layer EML cause the organic light-emitting layer EML to emit light. The light is radiated as emission light L externally upward from the anode AD side of the display device.

FIG. 2 shows the results of measurement on the relationship of the emission luminance to the thickness of the co-deposited layer, which has both Li and Alq₃ evaporated thereon and serves as the electron injection layer EIL, under the condition that a direct voltage of approximately 8V is applied to each of the anode AD and cathode CD. In the drawing, black diamond-shaped marks are concerned with a case where the ratio of Li to Alq₃ is 3, while black square marks are concerned with a case where the ratio of Li to Alq₃ is 1. As apparent from FIG. 2, the thinner the co-deposited layer made of Li and Alq₃ is, the smaller a quantity of resistive components is. Moreover, a current tends to increase and a luminance tends to rise. However, when the co-deposited layer is as thin as to be approximately 1 nm thick, the emission luminance of the light-emitting layer EML decreases markedly. Moreover, the luminous lifetime of the organic light-emitting elements gets shorter.

The decrease in the luminance is attributable to the fact that: the materials (Al and ITO) made into the reflective electrode CD1 and transmissive electrode CD2 constituting the cathode CD react on Li contained in the electron injection layer EIL on the interface between them; and Li is oxidized. Consequently, the thickness of the electron injection layer EIL should be equal to or larger than approximately 1 nm, or preferably, equal to or smaller than approximately 3 nm.

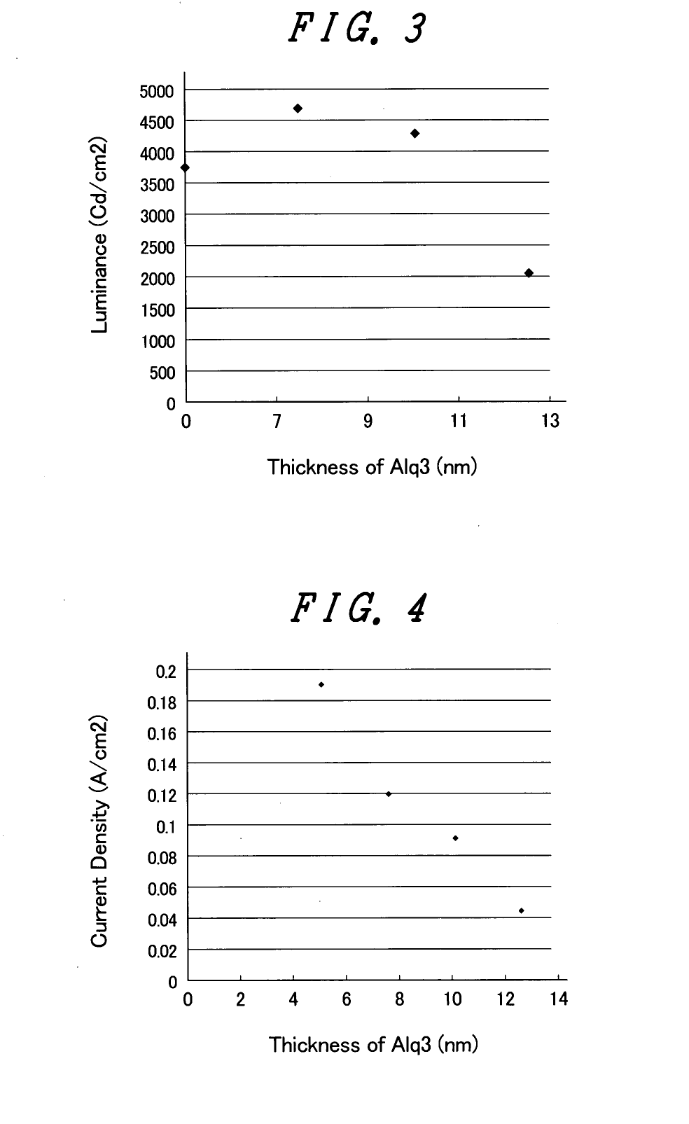

FIG. 3 shows the results of measurement on the relationship of an emission luminance to the thickness of an Alq₃-deposited layer, which serves as the electron transport layer ETL, under the condition that a direct voltage of approximately 8 V is applied to each of the anode AD and cathode CD. As apparent from FIG. 3, the thinner the Alq₃-deposited layer is, the smaller the quantity of resistive components is. Moreover, a current tends to increase and a luminance tends to improve. When the thickness of the Alq₃-deposited layer is equal to or smaller than approximately 5 nm, a decrease in the luminance is invited. When the thickness of the Alq₃-deposited layer is approximately 7.5 nm, the luminance is maximized.

The present inventor et al. produced a plurality of samples of the Alq₃-deposited layer, which has a thickness of approximately 10 nm, as the electron transport layer ETL, used a secondary ion mass spectrometer (SIMS) to analyze the elements of the samples, and measured the profiles in a depth direction of the Al layer and Li layer. The results of the elemental analysis demonstrated that Li was diffused by a thickness of about 7 nm into the Alq₃-deposited layer. The Alq₃-deposited layer has a property of acting as a barrier against the diffusion of Li and is effective in preventing the diffusion despite the relatively small thickness. Although the organic compound is initially bonded to Al in the form of a chelate, one of the electrons constituting the chelate is re-bonded to Li and thought to be trapped.

As a result of the analysis using the SIMS, the diffusion of Li is suspended at the thickness of approximately 7 nm, and the diffusion of Li into the organic light-emitting layer EML is limited. When Li invades into the light-emitting layer EML, light is put off. The luminance therefore decreases. Li should be approximately 0.1 atm % or less. In consideration of the luminous lifetime of each organic light-emitting element, Li should preferably be approximately 10 ppm or less. A condition under which Li does not invade into the light-emitting layer EML is that the thickness of the Alq₃-deposited layer serving as the electron transport layer ETL should be approximately 7.5 nm or more.

Moreover, multiple samples of the Alq₃-deposited layer having a thickness of approximately 5 nm were produced as the electron transport layer ETL, and the SIMS was used to perform elemental analysis. As a result, Li was detected earlier than Al was, and Li was found to be diffused into the Alq₃-deposited layer of approximately 5 nm or more thick. Further, in the sample of the Alq₃-deposited layer having the thickness of approximately 7 nm, Al and Li were detected simultaneously. The results of the analysis were squared with the results of the analysis performed on the sample of the Alq₃-deposited layer having a thickness of approximately 10 nm.

FIG. 4 shows the results of measurement on the relationship of a current density to the thickness of the Alq₃-deposited layer serving as the electron transport layer ETL under the condition that a direct voltage of approximately 8 V is applied to each of the anode AD and cathode CD. As shown in FIG. 4, the thinner the Alq₃-deposited layer is, the smaller a resistance is. Consequently, the current density increases. Therefore, the thickness of the Alq₃-deposited layer should preferably be equal to or larger than approximately 7.5 nm.

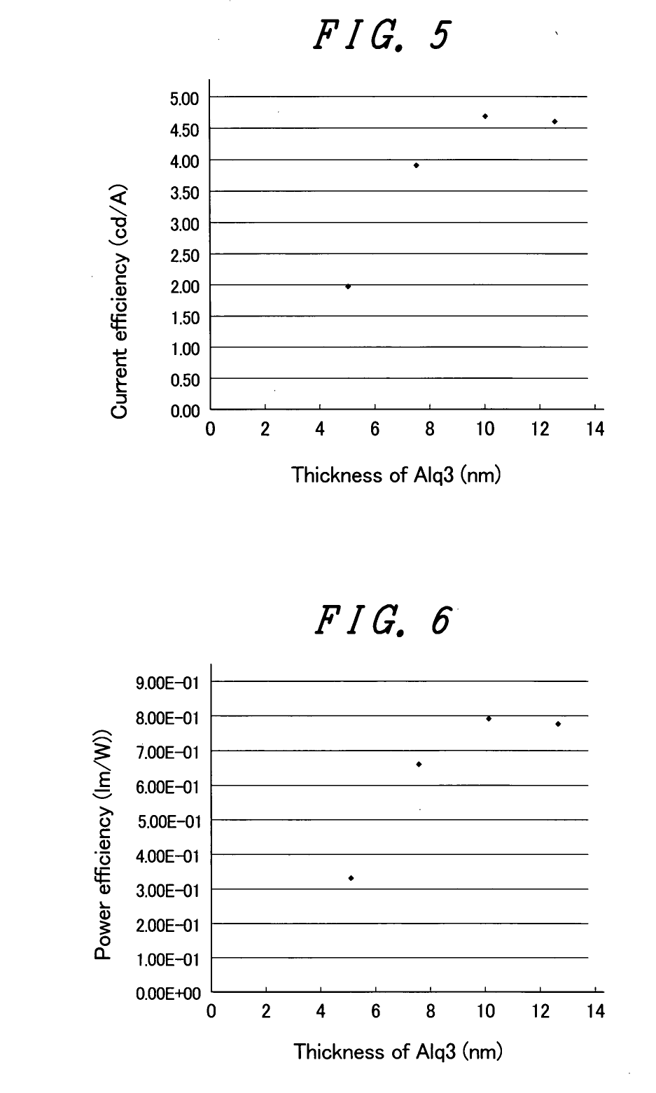

FIG. 5 shows the results of measurement on the relationship of a luminous current efficiency to the thickness of the Alq₃-deposited layer under the same driving condition as the foregoing ones. As shown in FIG. 5, when the thickness of the Alq₃-deposited layer is smaller than approximately 7.5 nm, Li in the electron injection layer EIL is diffused to invade into the light-emitting layer EML. This causes the luminous current efficiency to decrease rapidly. Therefore, the thickness of the Alq₃-deposited layer should preferably be equal to or larger than approximately 7.5 nm.

FIG. 6 shows the results of measurement on the relationship of a power efficiency to the thickness of the Alq₃-deposited layer under the same driving condition as the aforesaid ones. As shown in FIG. 6, when the thickness of the Alq₃-deposited layer becomes equal to or smaller than approximately 7.5 nm, the power efficiency rapidly decreases while reflecting the luminous current efficiency.

Consequently, the thickness of the Alq₃-deposited layer serving as the electron transport layer ETL should preferably be equal to or larger than approximately 5 nm and equal to or smaller than approximately 7.5 nm.

1. An organic light-emitting display device having at least a cathode, an electron injection layer, an electron transport layer, a light-emitting layer, and a hole transport layer sequentially accumulated on an insulating substrate, wherein:
the electron injection layer is realized with a co-deposited layer having both tris(8-hydroxyquinoline)aluminum and lithium evaporated thereon, and the electron transport layer is formed with a deposited layer having tris(8-hydroxyquinoline)aluminum evaporated thereon.

2. The organic light-emitting display device according to claim 1, wherein the ratio of tris(8-hydroxyquinoline)aluminum to lithium in the co-deposited layer serving as the electron injection layer is equal to or larger than 1 and equal to or smaller than 3.

3. The organic light-emitting display device according to claim 1, wherein the thickness of the co-deposited layer of tris(8-hydroxyquinoline)aluminum and lithium serving as the electron injection layer is equal to or larger than 1 nm and equal to or smaller than 3 nm.

4. The organic light-emitting display device according to claim 1, wherein the thickness of the deposited layer of tris(8-hydroxyquinoline)aluminum serving as the electron transport layer is equal to or larger than 5 nm and equal to or smaller than 7.5 nm.

5. The organic light-emitting display device according to claim 2, wherein the thickness of the deposited layer of tris(8-hydroxyquinoline)aluminum serving as the electron transport layer is equal to or larger than 5 nm and equal to or smaller than 7.5 nm.

6. The organic light-emitting display device according to claim 3, wherein the thickness of the deposited layer of tris(8-hydroxyquinoline)aluminum serving as the electron transport layer is equal to or larger than 5 nm and equal to or smaller than 7.5 nm.
